(19) United States
(12) Patent Application Publication
(10) Pub. No.: US 2020/0100574 A1
(43) Pub. Date: Apr. 2, 2020

(54) Hand Bag With Integrated Fingerprint lock and Zipper and/or Flap Closure

(71) Applicant: Rachel Bloom, Kettering, OH (US)

(72) Inventor: Rachel Bloom, Kettering, OH (US)

(21) Appl. No.: 16/241,313

(22) Filed: Jan. 7, 2019

Related U.S. Application Data
(63) Continuation-in-part of application No. 29/665,253, filed on Oct. 1, 2018, now Pat. No. D863758.
Application No. 29/665,253 is a continuation-in-part of application No. 29/671,327, filed on Nov. 26, 2018.

(51) Int. Cl. A45C 13/18; A45C 3/06; A45C 13/10; A45C 3/00; E05B 65/52; E05B 47/00; G07C 9/00

(52) U.S. Cl. CPC A45C 13/18; A45C 3/06; A45C 13/103; G07C 9/00563; E05B 65/5284; E05B 47/0001; A45C 3/001

(57) ABSTRACT

A hand bag having providing an open top has a zipper for closing the open top and has a tab for connecting to a fingerprint lock mounted on the hand bag.

### FIELD OF INVENTION

The instant invention relates to an improvement in hand bag designs. More particularly, the instant invention relates to a hand bag, such a purse, wallet, tote, clutch, concealment bag, or wallet, for example, having an improved locking structure.

### BACKGROUND OF INVENTION

The prior art includes various types of bags with locking mechanisms. More recently, these bags have included biometric features. One such prior example is CN201806072 directed to a wallet with fingerprint identification technique to prevent the theft wherein the wallet comprises a wallet purse body, an opening of the body is provided with an electronic wallet lock, the electronic lock connected to a controller, the controller connected to fingerprint lock and a buzzer and power source. The battery is a button battery. When the wallet is opened if the authorized fingerprint is not met, then an alarm sounds.

### SUMMARY OF THE INVENTION

It is an object to improve on the design of fingerprint lock bags.

An object is to improve on antitheft hand bag design.

Accordingly, one embodiment of the invention is directed to a hand bag having a bottom, sides connected to and extending from the bottom to provide forming a container with an open top. A zipper connects to the open top in a manner to enable closure of the top. The zipper has an end pull tab with a locking loop extending therefrom.

In another embodiment, one of the sides can preferably include an elongated upper end forming a flap which can fold over the open top and lay over a front face of an opposing side. The flap includes tab with a locking loop extending inwardly toward the face of the opposing side.

Integrally connected to the hand bag is a fingerprint lock having a housing with a front plate having a first opening for exposing a fingerprint identifying pad operably disposed in the housing and a second opening for receiving the locking loop therethrough, a power operated locking mechanism having a moving pin operably disposed in the housing which actuates the pin between a closed position below the second opening to lock the locking loop and an open position sufficiently disposed with respect to the second opening to not retain the locking loop when inserted through the second opening. A battery is operably disposed in the housing and connected to the powered operated locking mechanism.

The front plate has a back side formed with a plurality of threaded apertures and the housing has a complementary number of apertures through which mounting screws are inserted in a manner and through the housing on an inner side of the hand bag and through the hand bag to securely connect to the threaded apertures of the front plate to sandwich about a portion of the hang bag and secure the lock in place such that when the zipper fully closes the open top, the locking loop may be inserted into the second opening to enable the pin to move therethrough and lock the zipper in a closed position.

A controller is operably disposed in the housing and connected to the fingerprint pad and power operated locking mechanism for closing the opening and closing the pin based on a preprogrammed fingerprint identification being met. The handbag can preferably include a cut-proof material.

### BRIEF DESCRIPTION OF THE DRAWINGS

FIG. 1 is a front perspective view of a part of the hand bag of the invention.

FIG. 2 is another front perspective view with a lock in exploded relation to the hand bag in FIG. 1.

FIG. 3 is a front perspective view of an assembled embodiment of the invention.

FIG. 4 is a cut-away back perspective illustrating a housing part of the lock inside a hand bag of FIG. 1.

FIG. 5 is a top perspective view of a fingerprint lock of the invention in a locked mode.

FIG. 6 is a top perspective view of a fingerprint lock of the invention in an unlocked mode.

FIG. 7 illustrates front perspective of another embodiment of the invention.

FIG. 8 is a back view of the embodiment in FIG. 7.

FIG. 9 is a right side elevation end view of the embodiment in FIG. 7.

FIG. 10 is a left side of the embodiment in FIG. 7.

FIG. 11 is a top view of the embodiment in FIG. 7.

FIG. 12 is a bottom view of the embodiment in FIG. 7.

FIG. 13 illustrates front perspective of still another embodiment of the invention.

FIG. 14 is a back view of the embodiment in FIG. 13.

FIG. 15 is a right side elevation end view of the embodiment in FIG. 13.

FIG. 16 is a left side of the embodiment in FIG. 13.

FIG. 17 is a top view of the embodiment in FIG. 13.

FIG. 18 is a bottom view of the embodiment in FIG. 13.

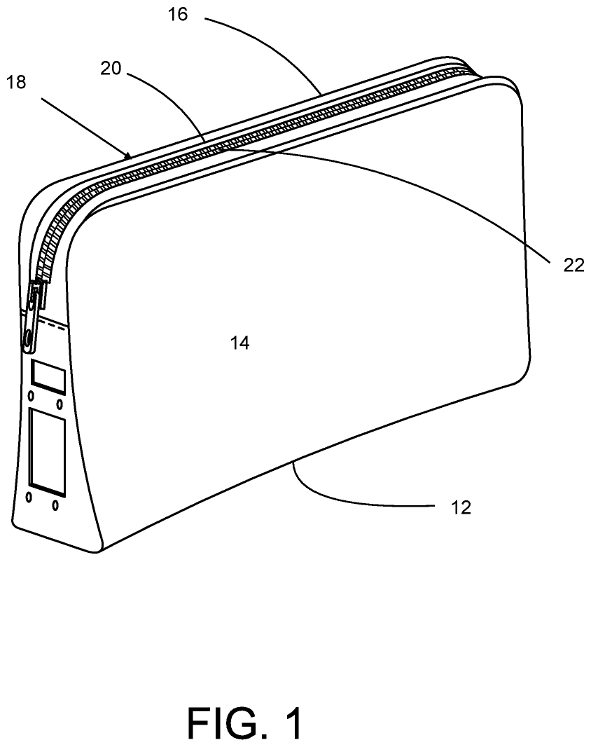

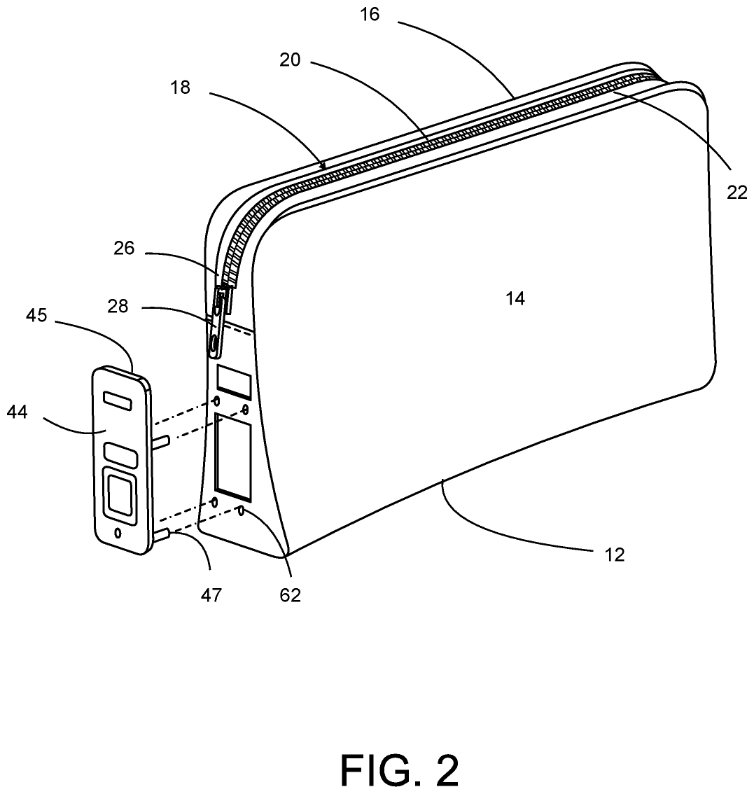

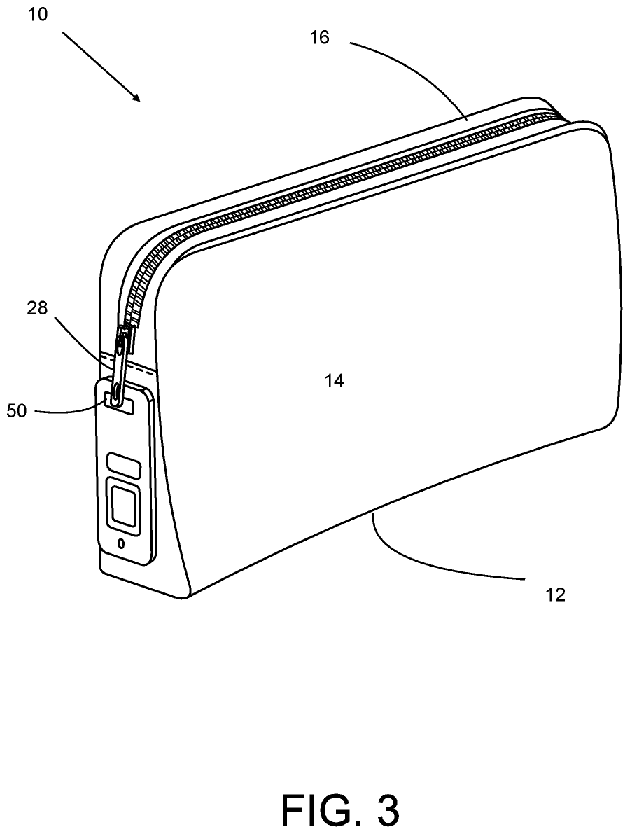

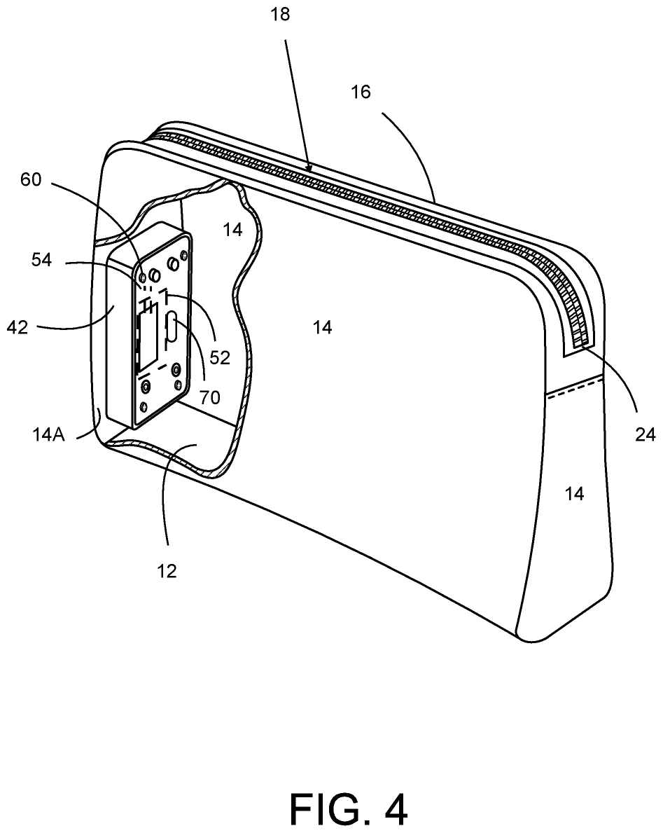

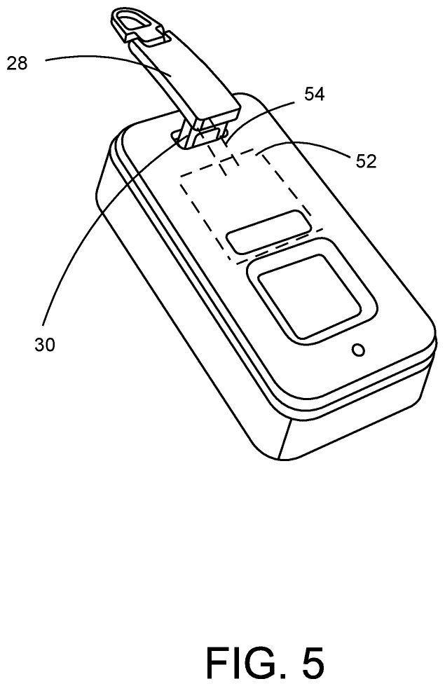

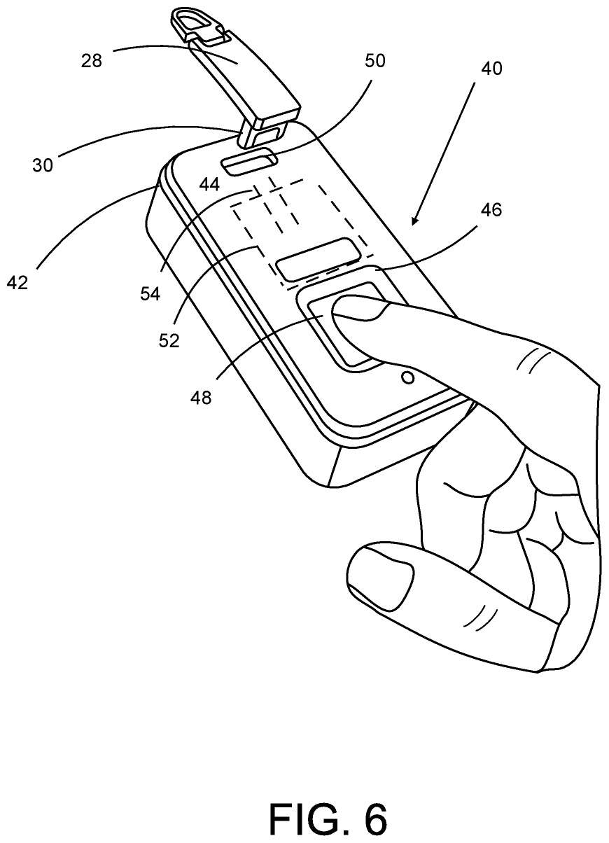

### DETAILED DESCRIPTION OF THE INVENTION

Referring now to the drawings, the hand bag with integrated fingerprint lock and zipper is generally referred by the numeral 10, where like parts are referenced with like numerals. The hand bag 10 has a bottom 12, sides 14, wherein it is contemplated that the side 14 could be connectively one or more piece(s), which connect to and extending from the bottom 12. The sides 14 and interconnect to each other and provide an open top 16. A zipper 18 connects to the open top 16 in a manner to enable closure of the top 16. The zipper 18 has two mating portions 20 and 22, a fixed end 24 and an openable end 26. A pull tab 28 is provided on zipper 18 for opening and closing the two mating portions 20 and 22 and has a locking loop 30 extending therefrom.

In another embodiment, one of the sides 14B can preferably include an elongated upper end 14B′ forming a flap which can fold over the open top 16 and lay over a front face of an opposing side 14C. The flap 14B′ includes tab 28′ with a locking loop extending inwardly toward the face of the opposing side 14C.

Integrally connected to the hand bag 10 is a fingerprint lock 40 having a housing 42 with a removable front plate 44. The front plate 44 has a first opening 46 for exposing a fingerprint identifying pad 48 operably disposed in the housing 42 and a second opening 50 for receiving the locking loop 30 of the pull tab 28 therethrough. A power operated locking mechanism 52 has a moving pin 54 operably disposed in the housing 42 which actuates the pin 54 between a closed position below the second opening 50 to lock the locking loop 30 and an open position sufficiently disposed with respect to the second opening 50 to not retain the locking loop 30 when inserted through the second opening 50. A battery 56 is operably disposed in the housing 42 and connected to the powered operated mechanism 52.

The front plate 44 has a back side 45 formed with a plurality of threaded apertures 47 and the housing 24 has a complementary number of apertures 25 through which mounting screws 60 are inserted in a manner and through the housing 42 on an inner surface of side 14A of the hand bag 10 and through respective holes 62 of the hand bag 10 to securely connect to the threaded apertures 47 of the front plate 44 to sandwich about a portion of side 14A of the hang bag 10 and secure the lock 40 in place. The lock 40 is disposed on the hand bag 40 such that when the zipper 18 fully closes the open top 16, the locking loop 30 of tab 28 may be inserted into the second opening 50 to enable the pin 54 to move therethrough and lock the zipper 18 in a closed position.

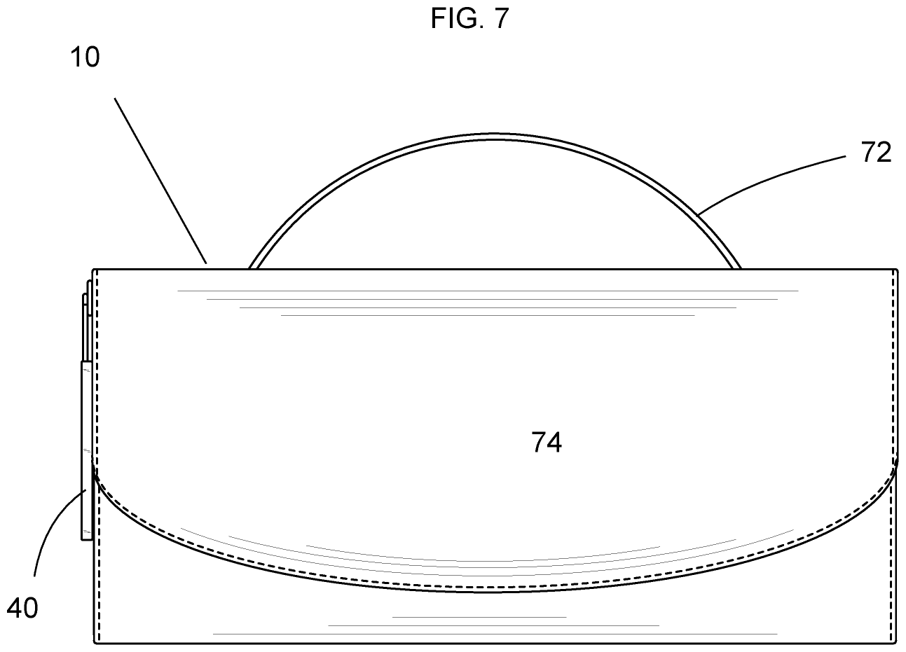

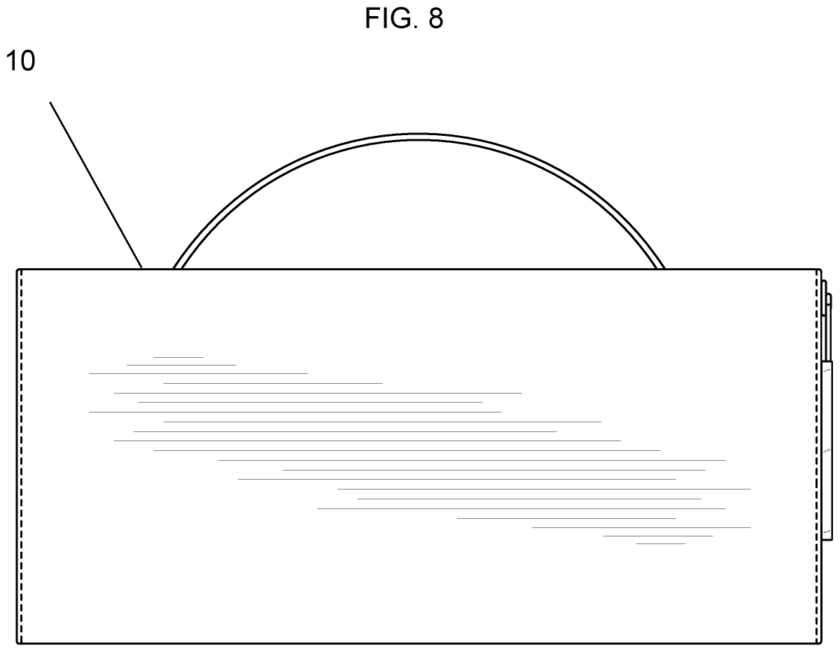

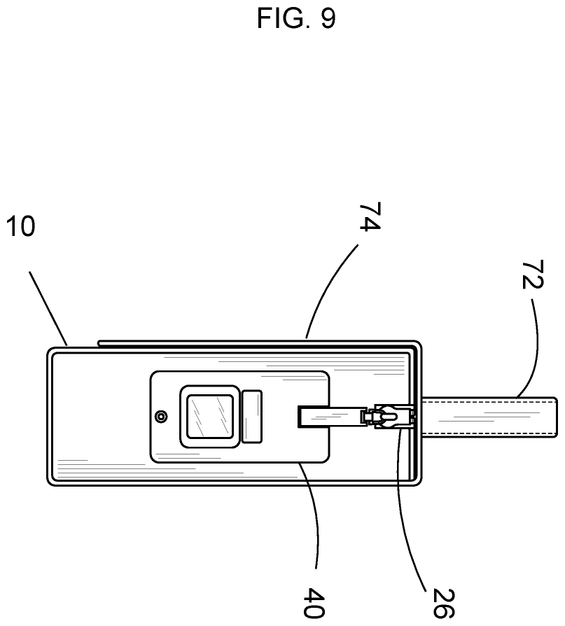

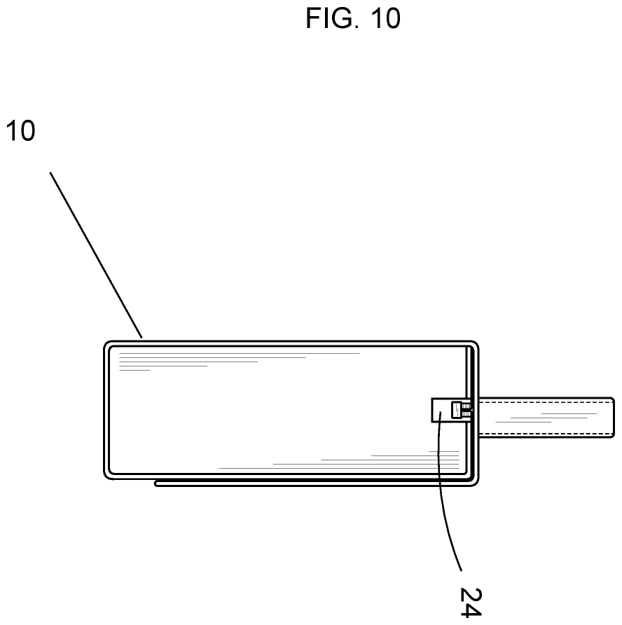

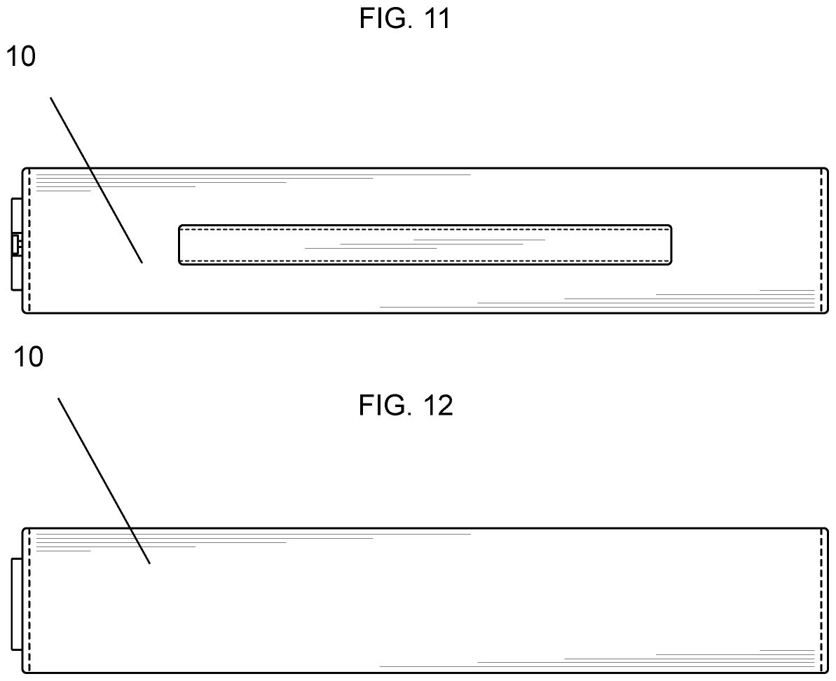

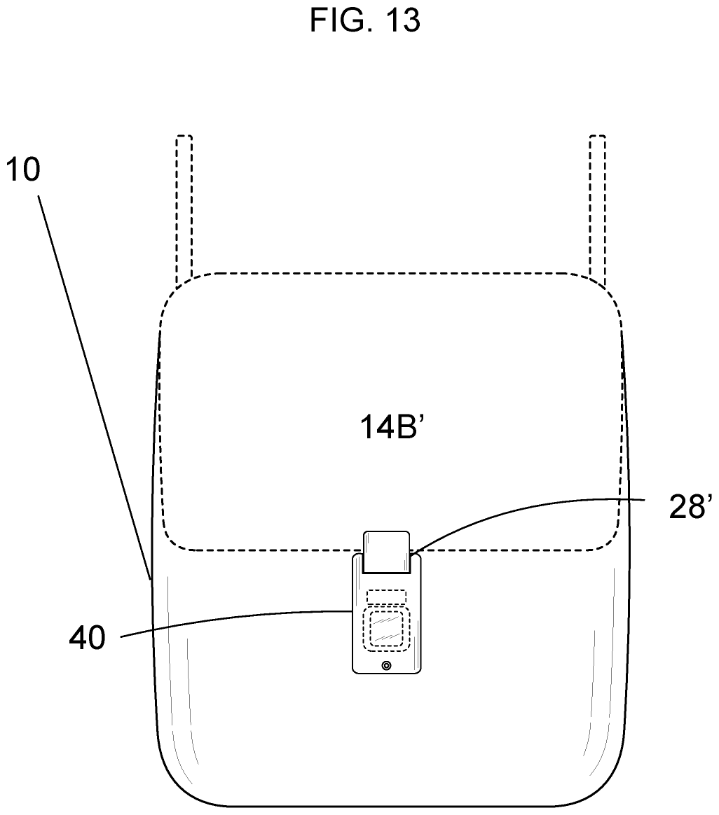

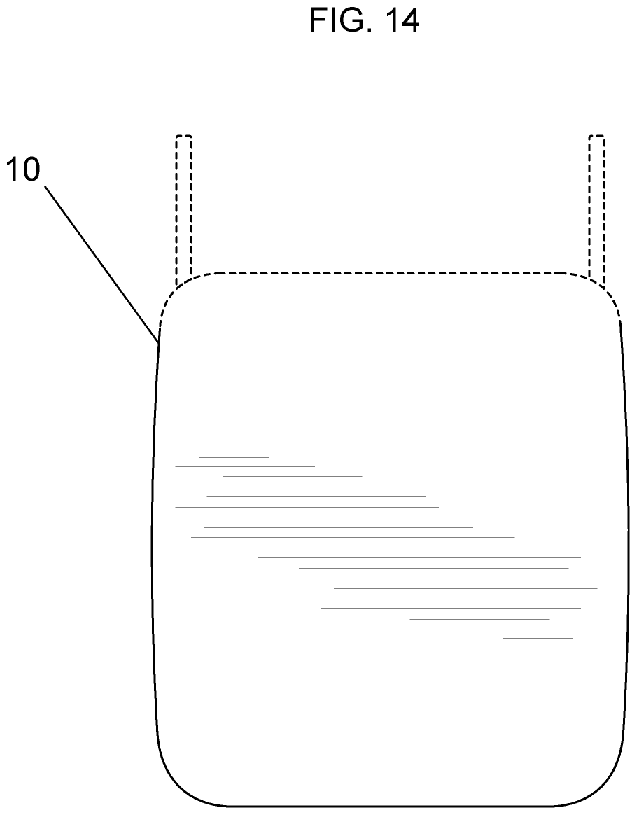

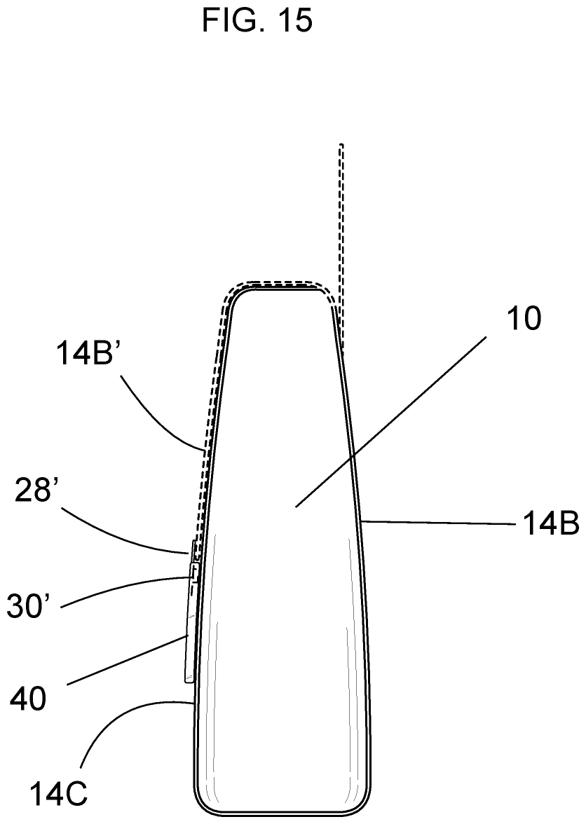

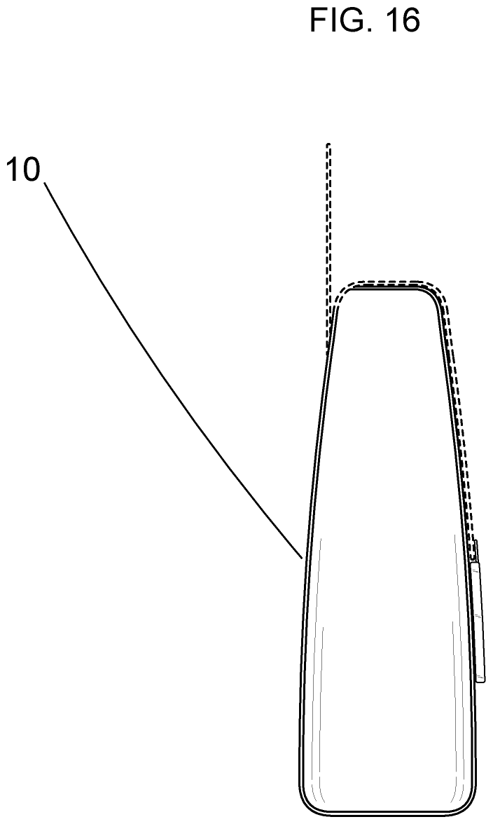

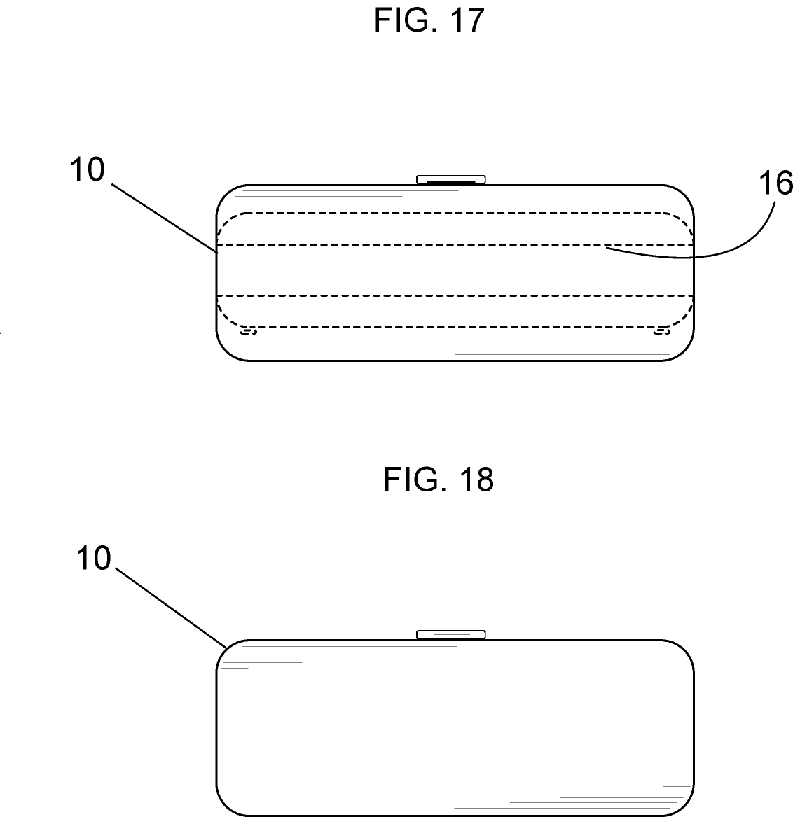

A controller 70 is operably disposed in the housing 42 and connected to the fingerprint pad 48 and power operated mechanism 52 for closing the opening and closing the pin 54 based on a preprogrammed fingerprint identification being met. A battery 56 is operably disposed in the housing 42 and connected to the controller 70 and powered operated mechanism 52. As seen in the embodiment seen in FIG. 7, the hand bag 10 can include a carrying strap 72 and a flap 74 covering the zipper 18, which could be several as seen in FIG. 13.

The handbag 10 can preferably include a cut-proof material. The instant claims are not to be overly limited by the above description. Rather, the claims appended hereto should be given the scope of protection to cover those modifications, improvements and derivations readily apparent to those skilled in the art.

1. A hand bag with a fingerprint lock, comprising:
a bottom;
one or more sides connected to and extending from the bottom and interconnecting to provide a container with an open top;
a zipper connecting to said open top in a manner to enable closure of said top, said zipper having an end pull tab with a locking loop extending therefrom;
a fingerprint lock Integrally connected to said hand bag having a housing with a removable front plate having a first opening for exposing a fingerprint identifying pad operably disposed in said housing and a second opening for receiving said locking loop of said pull tab therethrough, a power operated mechanism having a moving pin operably disposed in said housing which actuates said pin between a closed position below said second opening to lock said locking loop and an open position sufficiently disposed with respect to said second opening to not retain said locking loop when inserted through said second opening;
a battery is operably disposed in said housing; and
a controller is operably disposed in said housing and connected to said battery, said fingerprint pad and power operated mechanism for closing said opening and closing said pin based on a preprogrammed fingerprint identification being met.

2. The hand bag of claim 1, wherein said removable front plate has a back side formed with a plurality of threaded apertures and said housing has a complementary number of apertures through which mounting screws are inserted in a manner and through said housing on an inner side of said hand bag and through said hand bag to securely connect to said threaded apertures of said front plate to sandwich about a portion of said hang bag and secure the lock in place such that when said zipper fully closes said open top, said locking loop may be inserted into said second opening to enable said pin to move therethrough and lock said zipper in one of a closed and open position.

3. The handbag of claim 1, wherein said hand bag includes a cut-proof material.

4. The handbag of claim 1, which further includes a carrying strap connected thereto.

5. A hand bag with a fingerprint lock, comprising:
a bottom;
one or more sides connected to and extending from the bottom and interconnecting to provide a container with an open top;
a flap extending from said one or more side which folds over said open top and lays over a front face of an opposing side of said one or more sides in a manner to enable closure of said top, said flap having a tab with a locking loop extending therefrom;
a fingerprint lock Integrally connected to a front face of one of said one or more sides of said hand bag having a housing with a removable front plate having a first opening for exposing a fingerprint identifying pad operably disposed in said housing and a second opening for receiving said locking loop of said pull tab therethrough, a power operated mechanism having a moving pin operably disposed in said housing which actuates said pin between a closed position below said second opening to lock said locking loop and an open position sufficiently disposed with respect to said second opening to not retain said locking loop when inserted through said second opening;
a battery is operably disposed in said housing; and
a controller is operably disposed in said housing and connected to said battery, said fingerprint pad and power operated mechanism for closing said opening and closing said pin based on a preprogrammed fingerprint identification being met.

6. The hand bag of claim 5, wherein said removable front plate has a back side formed with a plurality of threaded apertures and said housing has a complementary number of apertures through which mounting screws are inserted in a manner and through said housing on an inner side of said hand bag and through said hand bag to securely connect to said threaded apertures of said front plate to sandwich about a portion of said hang bag and secure the lock in place such that when said flap fully closes said open top and rests against said face, said locking loop may be inserted into said second opening to enable said pin to move therethrough and lock said flap in one of a closed and open position.

7. The handbag of claim 5, wherein said hand bag includes a cut-proof material.

8. The handbag of claim 5, which further includes a carrying strap connected thereto.

9. The handbag of claim 5, which further includes a zipper connecting to said open top in a manner to enable closure of said top and which is disposed below said flap.
